(19) United States
(12) Patent Application Publication
(10) Pub. No.: US 2024/0182012 A1
(43) Pub. Date: Jun. 6, 2024

(54) ELECTRONICALLY SLIP-CONTROLLABLE POWER BRAKE SYSTEM

(71) Applicant: Robert Bosch GmbH, Stuttgart (DE)

(72) Inventors: Andreas Weh, Sulzberg (DE); Alexander Bareiss, Immenstadt, DE (US); Martin Hagspiel, Rettenberg (DE)

(21) Appl. No.: 18/462,615

(22) Filed: Sep. 7, 2023

(30) Foreign Application Priority Data
Dec. 6, 2022 (DE) 10 2022 213 133.9

(51) Int. Cl. B60T 13/58; B60T 8/176; B60T 8/40; B60T 13/14; B60T 13/68; B60T 13/74

(52) U.S. Cl. CPC B60T 13/58; B60T 8/176; B60T 8/4081; B60T 13/142; B60T 13/686; B60T 13/746; B60T 2270/10

(57) ABSTRACT

An electronically slip-controllable power brake system, The system includes pressure-medium-actuable wheel brakes on a first axle and electromechanically actuable wheel brakes on a second axle of a motor vehicle. A hydraulic unit is provided having a brake master cylinder for specifying a braking request by the driver, a simulator coupled thereto for providing haptic feedback to the driver, a first electronic controller for electrically activating a drive motor of a brake pressure generator using external energy, and a pressure modulator for adjusting one wheel-specific wheel brake pressure per pressure-medium-actuable wheel brake. A controllable first pressure medium connection is provided between the brake master cylinder and the simulator and a controllable second pressure medium connection is provided between the brake master cylinder and one of the pressure-medium-actuated wheel brakes.

### CROSS REFERENCE

The present application claims the benefit under 35 U.S.C. § 119 of German Patent Application No. DE 10 2022 213 133.9 filed on Dec. 6, 2022, which is expressly incorporated herein in its entirety.

### FIELD

The present invention relates to an electronically slip-controllable power brake system.

### BACKGROUND INFORMATION

Power brake systems differ from conventional vehicle brake systems in that, when they are operated under normal conditions, the driver is not involved in building up brake pressure, but merely specifies a braking request. This braking request is detected by a sensor unit and is further processed by an electronic controller into an activation signal for a drive of a pressure generator. This pressure generator ultimately provides the desired brake pressure.

To specify the braking request, the driver actuates a brake actuation element, which is coupled to a cylinder piston of a brake master cylinder. The cylinder piston delimits a cylinder chamber, the volume of which then decreases and the chamber pressure of which accordingly increases. The chamber pressure that has built up and the distance traveled by the cylinder piston are electrically detected by sensors or sensor units. The corresponding signals are supplied to the electronic controller.

The power brake system forming the basis of the present invention comprises pressure-medium-actuable wheel brakes on a first axle and electromechanically actuable wheel brakes on a second axle of a motor vehicle. In professional circles, because of their different brake actuator principles, vehicle brake systems of this kind are also called hybrid brake systems.

Hydraulic units for adjusting and/or controlling the brake pressure on pressure-medium-actuable wheel brakes of vehicle brake systems have been part of the prior art since electronic traction control was introduced in ABS/ASR/ESP brake systems.

The hydraulic units comprise a cuboid housing block, which has a pressure generator and an attached, electrically activatable drive motor to drive said pressure generator. The drive motor is activated as needed by an electronic controller, which is fastened to the housing block so as to be opposite the drive motor.

Hydraulic units of power brake systems also integrate in this housing block the brake master cylinder, actuable by the driver, for specifying the braking request, and the sensors or sensor units required for detecting the braking request and/or for controlling the brake pressure. A position decoder composed of a signal transmitter, actuable together with the brake master cylinder, and an associated signal receiver, which is arranged so as to be stationary on the housing block, is already available.

A hydraulic unit is shown, by way of example, in FIG. 1 of German Patent Application No. DE 10 2020 216 113 A1 on the basis of a hydraulic circuit diagram. FIG. 4 of this document also shows the hydraulic unit following final assembly.

For proper operation of the hydraulic unit, an intact power supply to the electronic controller, to the sensor system, and to the electrically activatable, pressure-medium-conducting components is required. Since faults in these elements cannot be ruled out with certainty, however, precautions need to be taken so that the vehicle can be safely braked in the event of a fault of this kind.

Equipping the vehicle braking system with redundant systems throughout is complex, particularly in terms of cost and installation space, and accordingly unappealing.

### SUMMARY

According to the present invention, so that the vehicle equipped with the hydraulic unit can be safely braked in the event of a fault in the power supply, the power brake system has a hydraulic fallback solution or hydraulic intervention. This is a first pressure medium connection, which can be operated in the event of a fault, between the brake master cylinder and a simulator, and an operable second pressure medium connection between the brake master cylinder and the pressure-medium-actuable wheel brakes. The electronic controller is also configured to operate the pressure medium connections in opposite directions from one another, such that the first pressure medium connection is open when the second pressure medium connection is closed, and vice versa. In the event of a fault in the electrical system or its components, the hydraulic fallback solution allows the driver to build up brake pressure in the pressure-medium-actuated wheel brakes by manual control and thus to brake the vehicle to a standstill.

Further advantages or advantageous developments of the present invention become apparent from the disclosure herein.

### BRIEF DESCRIPTION OF THE DRAWINGS

An exemplary embodiment of the present invention is shown in the figures and is explained in detail in the following description.

A total of three figures are provided, in which components or units that correspond to one another are provided with the same reference signs throughout.

FIG. 1 is a highly simplified, schematic plan view of a motor vehicle equipped with a hybrid braking system.

FIG. 2 shows a first exemplary embodiment of a hydraulic circuit diagram of a power brake system according to the present invention.

FIG. 3 shows a second exemplary embodiment of a hydraulic circuit diagram of this kind, according to the present invention.

### DETAILED DESCRIPTION OF EXAMPLE EMBODIMENTS

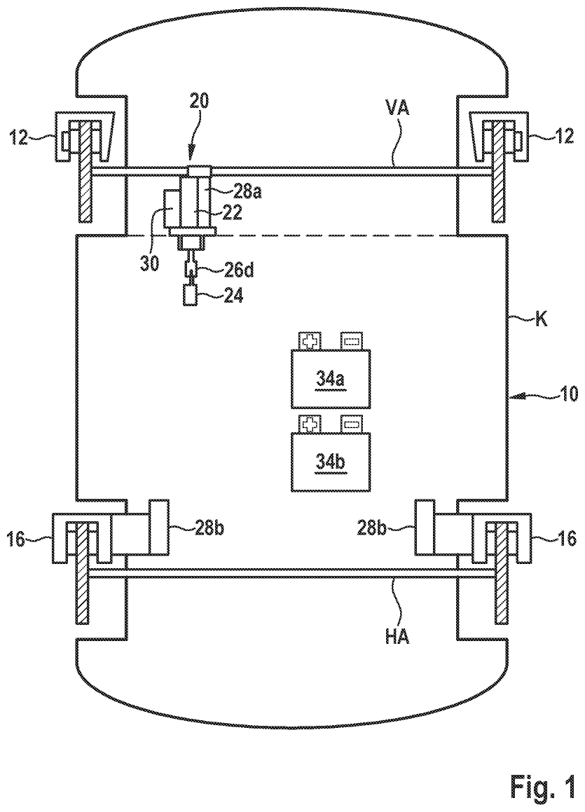

FIG. 1 is a plan view of a vehicle body K of a motor vehicle. This motor vehicle is equipped with an electronically slip-controllable power brake system (10), which is configured as a hybrid brake system and accordingly comprises pressure-medium-actuable wheel brakes (12) on a first vehicle axle (VA) and electromechanically actuable wheel brakes (16) on a second vehicle axle (HA). The first vehicle axis (VA) fitted with the pressure-medium-actuable wheel brakes (12) is preferably the front axle of the motor vehicle, while the electromechanical wheel brakes (16) are preferably arranged on the rear axle (HA) of the motor vehicle.

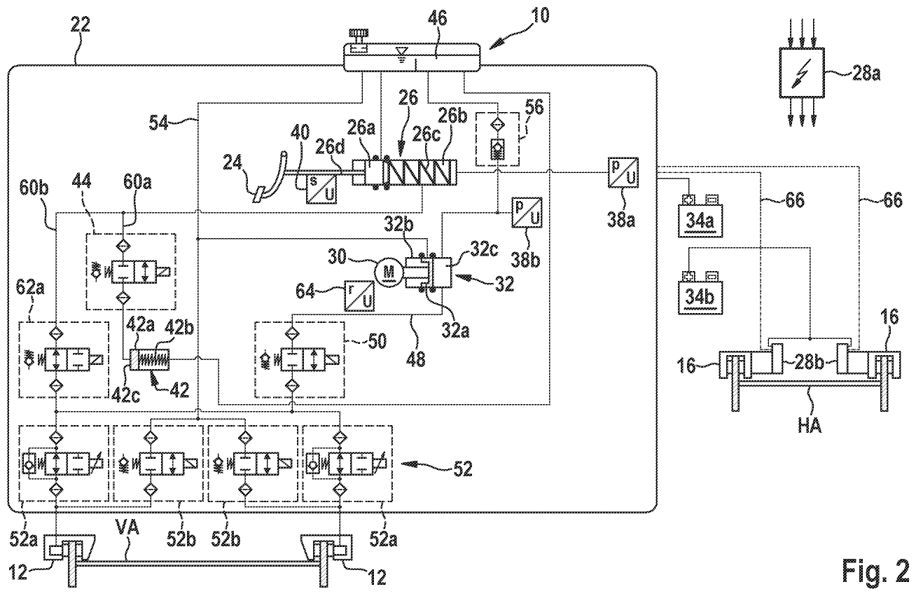

For specifying a braking request by a driver, inter alia, the power brake system (10) comprises a hydraulic unit (20), which is fastened to a splashboard between an engine compartment and a passenger compartment of the motor vehicle. This hydraulic unit (20) comprises a central housing block (22) having an integrated brake master cylinder (26; FIG. 2) that can be actuated by the driver via a brake pedal (24) or, alternatively, a hand brake lever. In addition to the above-mentioned detection of the braking request, the hydraulic unit (20) is intended to provide a brake pressure in line with the braking request and to control this brake pressure on the basis of the prevailing slip ratios at the respective wheels of the motor vehicle. For this purpose, a first electronic controller (28a) and an electrically activatable drive motor (30) for driving a brake pressure generator (32) are attached to opposing outer surfaces of the housing block (22) of this hydraulic unit (20).

The first electronic controller (28a) is supplied with electrical power by a first power supply unit (34a) provided on the motor vehicle. A second power supply unit (34b) independent of this first power supply unit (34a) supplies power to the electromechanical wheel brakes (16) on the rear axle of the motor vehicle.

FIG. 2 shows a first exemplary embodiment of a hydraulic circuit diagram of an electronically slip-controllable power brake system (10) forming the basis for the present invention.

The above-mentioned housing block (22) of this hydraulic unit (20) is indicated in FIG. 2 by a solid, closed outline. The brake master cylinder (26), which is configured as a single brake master cylinder in the exemplary embodiment shown, is arranged in the interior of this housing block (22). This brake master cylinder (26) comprises a master cylinder piston (26a), which together delimit a single master cylinder chamber (26b). A piston return spring (26c), which urges the master cylinder piston (26a) toward its starting position, is housed in this master cylinder chamber (26b). The master cylinder piston (26a) is coupled to an actuation rod (26d) on its side facing away from the piston return spring (26c). The actuation element, which, by way of example, is configured as a brake pedal (24) according to FIG. 2, is articulated to the end of this actuation rod (26d) remote from the piston. The driver thus actuates this brake pedal (24) counter to the force of the piston return spring (26c).

As the actuator travel increases, the volume of the master cylinder chamber (26b) decreases and the pressure in its interior increases. This change in pressure can be detected by a first pressure sensor (38a) connected to the master cylinder chamber (26b). The first pressure sensor (38a) outputs an electrical sensor signal to the first electronic controller (28).

In addition, a sensor unit (40) composed of a signal receiver and a signal transmitter is provided for detecting actuator travel of the actuation rod (26d). For this purpose, the signal transmitter is securely anchored to the actuation rod (28d) and moves relative to the signal receiver (not shown), which is anchored to the housing block (22) so as to be stationary.

The single master cylinder chamber (26b) of the brake master cylinder (26) is connected to a simulator (42) via a controllable first pressure medium connection (60a). This simulator is provided to receive the pressure medium that is displaced out of the master cylinder chamber (26b) when the brake master cylinder (26) is actuated. The simulator (42) is a piston-cylinder unit comprising a simulator piston (42a) and a simulator spring (42b), which urges the simulator piston (42a) counter to the force of the pressure medium flowing into a simulator chamber (42c). When it actuates the brake, the simulator (42) enables actuator travel of the actuation element (brake pedal 24), provides the driver, via the actuation element, with force feedback which allows them to feel that their braking request has been set, and makes it possible to build up brake pressure in the master cylinder chamber (26b).

The above-mentioned first pressure medium connection (60a) between the brake master cylinder (26) and the simulator (42) can be controlled by a simulator control valve (44), which is arranged upstream of the simulator (42). This simulator control valve (44) is a switching valve that can be activated by the first electronic controller (28a) and can be switched from its normally closed home position into an open position. When the power supply is intact, the simulator control valve (44) of the power brake system (10) is open and, during a braking process, supplies the pressure medium that has been displaced out of the master cylinder chamber (26b) of the brake master cylinder (26) by the driver to the simulator (42). Conversely, if the power supply is defective, the simulator control valve (44) is closed and thus closes off the simulator (42) from the brake master cylinder (26).

A space in the simulator (42) in which the simulator spring (42b) is received is directly connected to a pressure medium reservoir (46) via a pressure medium line. This pressure medium reservoir comprises a container, which is mounted on the outside of the housing block (22) of the hydraulic unit (20) and is coupled to the housing block (22) via a plurality of pressure medium connections, in this exemplary embodiment a total of four, for exchanging pressure medium.

Another of the pressure medium connections leads to a brake pressure generator (32) arranged on the housing block (22) via a pressure medium connection configured to be controllable. This brake pressure generator (32) is a plunger piston (32a), which is displaceably received in a plunger cylinder (32b) and delimits a plunger working chamber (32c) formed between the plunger piston (32a) and the plunger cylinder (32b). The plunger piston (32a) can be driven by the electrically activatable drive motor (30) to produce a translational movement within the plunger cylinder (32b), as a result of which the plunger working chamber (32c) changes its volume. If this volume decreases, the plunger piston (32a) displaces pressure medium under brake pressure out of the plunger working chamber (32b) [sic. correct numeral: (32c)] into a connected brake circuit (48) having the two pressure-medium-actuated wheel brakes (12) connected thereto. If, however, the volume of the plunger working chamber (32c) increases, pressure medium flows out of this brake circuit (48) back into the plunger working chamber (32c) and the brake pressure in these wheel brakes (12) drops.

As already mentioned, the pressure-medium-actuated wheel brakes (12) are assigned to a shared first axle (VA) of the motor vehicle, this being the front axle in this exemplary embodiment.

As shown in the exemplary embodiment according to FIG. 2, the brake pressure generator (32) is connected to a single brake circuit (48) having two contacted wheel brakes (12). This connection can be controlled by a normally closed plunger control valve (50). In the closed state (home position), this plunger control valve (50) allows the plunger piston (32a), when it is driven in the pressure reduction direction, to draw pressure medium from the pressure medium reservoir (46) into the plunger working chamber (32c) without causing a change in brake pressure in the contacted wheel brakes (12) in the process.

A pressure modulator (52) is connected upstream of the hydraulically actuable wheel brakes (12). By way of example, per wheel brake (12), this consists of a pair of electrically activatable directional valves, i.e., a normally open inlet valve (52a) and a normally closed outlet valve (52b). When these directional valves are electrically activated by way of the first electronic controller (28), the brake pressures of the hydraulic wheel brakes (12) can be adjusted in a wheel-specific manner, and thus wheel slip that might occur on any of the assigned wheels can be controlled as required.

When traction control is underway, the inlet valve (52a) assigned to the wheel brake (12) is closed and the outlet valve (52b) is open, such that pressure medium flows out of the wheel brake (12) and reaches a further hydraulic connection of the pressure medium reservoir (46) via a return line (54), which is shared by both wheel brakes (12). This return line (54) also leads back to the pressure medium reservoir (46) directly, i.e., without any interposed pressure-medium-controlling equipment.

The supply line of the brake pressure generator (32), as already mentioned above, discharges into the plunger working chamber (32c) and is indirectly connected to the pressure medium reservoir (46) via an interposed supply valve (56). A hydraulically actuable, spring-loaded non-return valve, through which the medium can flow in the direction from the pressure medium reservoir (46) to the brake pressure generator (32) or which has a closing effect in the opposite direction, is provided as the supply valve (56). An additional second pressure sensor (38b), which is used to detect a brake pressure provided by the brake pressure generator (32), is provided in the supply line between the supply valve (56) and the brake pressure generator (32). The corresponding electrical sensor signal is also evaluated by the first electronic controller (28a) for brake pressure control and, for example, is checked for plausibility using the signal from the first pressure sensor (38a).

According to the present invention, a controllable second pressure medium connection (60b), which leads from the master cylinder chamber (26b) of the brake master cylinder (26) to the pressure-medium-actuated wheel brakes (12) via the pressure modulator (52) and can be controlled by an isolation valve (62) electrically activatable by the first electronic controller (28a), is provided on the housing block (22) of the hydraulic unit (22) [sic. correct numeral: (20)]. Just like the inlet valves (52a) of the pressure modulator (52), this isolation valve (62) is normally open; therefore, in a home position, i.e., in the state in which it is not electrically activated, there is an open pressure medium connection between the brake master cylinder (26) and the pressure-medium-actuated wheel brakes (12). In the event of a fault in the first power supply unit (34a), by actuating the brake master cylinder (26) the driver is thus capable of building up brake pressure in the pressure-medium-actuated wheel brakes (12) by manual control and of braking the vehicle in this way.

The first pressure medium connection (60a), which can be controlled by the simulator control valve (44), between the brake master cylinder (26) and the simulator (42), and the second pressure medium connection (60b), which can be controlled by the isolation valve (62), between the brake master cylinder (26) and the pressure-medium-actuable wheel brakes (12) can be controlled in opposite directions to one another by the first electronic controller (28a), as explained. This means that, when the power supply to the power brake system (10) is intact, the respective valves are activated by the first electronic controller (28a) such that the first pressure medium connection (60a) is open and the second pressure medium connection (60b) is closed, whereas, conversely, in the event of a fault in the first power supply unit (34a) resulting in the valves no longer being able to be activated, the first pressure medium connection (60a) is closed by way of the simulator control valve (44), which is closed when de-energized, and the second pressure medium connection (60b) is open owing to the isolation valve (62), which is open when de-energized.

Lastly, a rotor position sensor (64) for detecting a rotational movement of a rotor of the drive motor (3) for the brake pressure generator (32) is provided on the housing block (22) of the hydraulic unit (20). The electrical signal therefrom is likewise supplied to the first electronic controller (28a) for evaluation. The signal allows conclusions to be drawn on actuator travel of the plunger piston (32a) and on the volume of pressure medium displaced by the plunger piston movement and thus on the pressure level to be expected in the brake circuit (48).

As explained, the wheel brakes on the second axle (HA) of the motor vehicle are electromechanical wheel brakes (16), which can be pre-loaded by a respective electrically activatable braking actuator, optionally via an interposed transmission, and provide a braking torque in line with the activation signal or the braking request.

FIG. 2 also shows details of the power supply and the signal transmission within the power brake system (10). In this respect, this figure shows the two first and second power supply units (34a, 34b), which are configured to be separate from one another. While the first power supply unit (34a) supplies the first electronic controller (28a) on the hydraulic unit (14) [sic. correct numeral: (20)] with electrical power, the second power supply unit (34b) is assigned to the second electronic controllers (28b) on the electromechanical wheel brakes (16) of the second axle (18) of the motor vehicle.

In normal operation, i.e., when the first power supply unit (34a) of the power brake system (10) explained above is intact, the pressure-medium-actuable wheel brakes (12) on the first axle (14) of the motor vehicle interact with the electromechanical wheel brakes (16) on the second axle (18) of the motor vehicle to generate a total braking torque. To do this, any braking request specified is detected by the sensor unit (40) on the basis of the actuator travel of the actuation rod (26d) and is supplied to the first electronic controller (28a) fastened to the hydraulic unit (20). This first controller (28a) further processes the incoming sensor signal into an activation signal for the drive motor (30) of the hydraulic brake pressure generator (32), which accordingly applies hydraulic brake pressure to the hydraulic wheel brakes (12) on the first axle (VA) of the motor vehicle. At the same time, the braking request signal is relayed from the first electronic controller (28a) to the two second controllers (28b) of the electromechanically actuable wheel brakes (16) on the second axle (18) of the motor vehicle via signal lines (66). These second controllers (28b) convert the incoming braking request signal into actuation signals for activating braking actuators, using which the electromechanically actuable wheel brakes (16) are applied.

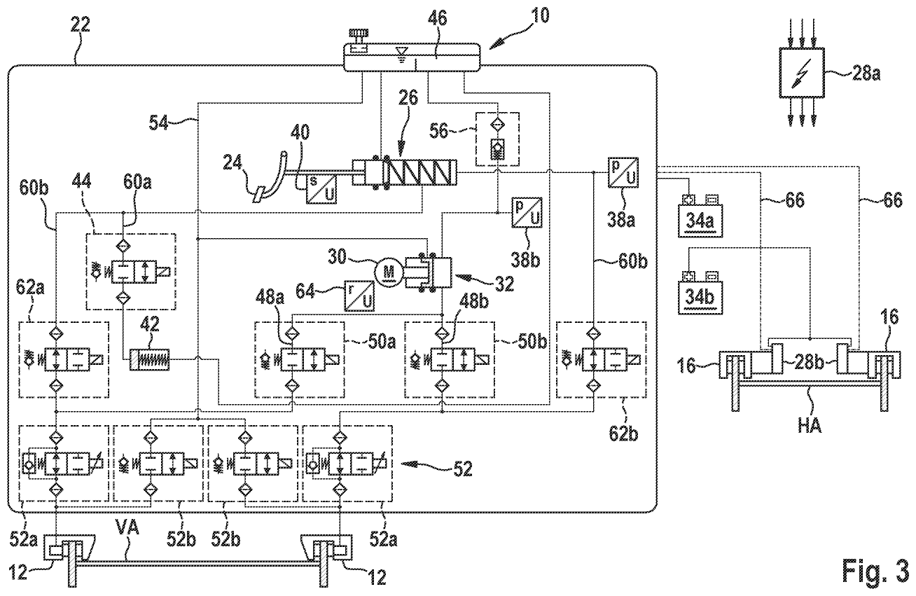

FIG. 3 shows a second exemplary embodiment of the present invention.

This exemplary embodiment differs from the above-described first exemplary embodiment in that there are now two separate brake circuits (48a, 48b) on the brake pressure generator (32), which are each connected to a contacted wheel brake (12). Each of these two brake circuits (48a, 48b) is connected to the brake pressure generator (32) for control in an unchanged manner, and accordingly they each comprise an assigned plunger control valve (50a, 50b), which is arranged downstream of the brake pressure generator (32) and upstream of the pressure modulator (52). Altogether, a total of two plunger control valves (50a, 50b) are therefore provided.

Furthermore, the controllable second pressure medium connection (60b) between the brake master cylinder (26) and the pressure-medium-actuated wheel brakes (12) is configured in duplicate. Accordingly, the power brake system (10) according to FIG. 3 is also equipped with two isolation valves (62a, 62b), each one for controlling one of said so-called second pressure medium connections (60b).

The two plunger control valves and isolation valves in each case increase the installation complexity of the power brake system (10) according to FIG. 3, but, conversely, in the event of a fault at the first power supply unit (34a), provide the option of building up brake pressure by manual control in just one brake circuit (48a; 48b) or just one of the pressure-medium-actuated wheel brakes (12) while the other brake circuit (48b, 48a) or the other of the pressure-medium-actuated wheel brakes (12) remains unpressurized. In other words, in the second exemplary embodiment, the two brake circuits (48a, 48b) are separate from one another, which further improves the reliability of the power brake system (10), for example if there were a leak in one of the brake circuits (48a, 48b) in addition to the fault in the power supply. If this were to happen, in the second exemplary embodiment the leaking brake circuit (48a, 48b) would be able to be uncoupled from a pressure medium supply and the vehicle could still be braked via the intact second brake circuit.

It goes without saying that further modifications or additions to the above-described exemplary embodiments are possible without departing from the scope of protection of the present invention.

In this context, it is noted by way of example that the two exemplary embodiments use a more compact and cost-effective single cylinder as the brake master cylinder. Alternatively, however, it would also be possible to use a conventional tandem cylinder.

What is claimed is:

1. An electronically slip-controllable power brake system, comprising:
pressure-medium-actuable wheel brakes on a first axle of a motor vehicle;
electromechanically actuable wheel brakes on a second axle of the motor vehicle; and
a hydraulic unit configured to supply the pressure-medium-actuable wheel brakes with a pressure medium under brake pressure, wherein the hydraulic unit includes:
a brake master cylinder which includes a master cylinder piston which is displaceably received and is coupled to a brake actuation element, for specifying a braking request by the driver,
a simulator coupled to the brake master cylinder configured to specify an actuator travel and an actuating force of the brake actuation element,
a first electronic controller which is supplied with electrical power by a first power supply unit and identifies an activation signal based on the braking request that has been specified,
a brake pressure generator which can be driven by external energy based on the activation signal, for conveying the pressure medium under brake pressure to the pressure-medium-actuated wheel brakes, and
a pressure modulator which can be controlled by the first electronic controller, for adjusting a wheel-specific wheel brake pressure,
wherein a controllable first pressure medium connection between the brake master cylinder and the simulator, and a controllable second pressure medium connection between the brake master cylinder and a pressure-medium-actuated wheel brake are provided, and wherein the first electronic controller is configured to control the first and second pressure medium connections in opposite directions to one another, such that the first pressure medium connection is open when the second pressure medium connection is closed or the first pressure medium connection is closed when the second pressure medium connection is open.

2. The electronically slip-controllable power brake system as recited in claim 1, wherein each of the pressure-medium-actuated wheel brakes is contacted to the master cylinder chamber of the brake master cylinder via a controllable second pressure medium connection.

3. The electronically slip-controllable power brake system as recited in claim 1, wherein, for controlling the first pressure medium connection, a simulator control valve activatable by the first electronic controller is provided and assumes a closed position when de-energized and an open position when energized.

4. The electronically slip-controllable power brake system as recited in claim 1, wherein, for controlling the second pressure medium connection, an isolation valve activatable by the first electronic controller is provided and assumes an open position when de-energized and a closed position when energized.

5. The electronically slip-controllable power brake system as recited in claim 1, wherein the vehicle brake system is equipped with a second electronic controller for activating the electromechanically actuable wheel brakes in a wheel-specific manner.

6. The electronically slip-controllable power brake system as recited in claim 5, wherein the second electronic controller is supplied with electrical power by a second power supply unit, the second power supply unit being separate from and independent of the first power supply unit.

7. The electronically slip-controllable power brake system as recited in claim 5, wherein the braking request is detected by the first electronic controller by evaluating a sensor signal from a sensor unit, and the first electronic controller relays the braking request to the second electronic controller.

8. The electronically slip-controllable power brake system as recited in claim 1, wherein the brake pressure generator is connected to the pressure-medium-actuable wheel brakes via a third pressure medium connection, and a plunger control valve, activatable by the first electronic controller, for controlling the third pressure medium connection is assigned to the pressure-medium-actuable wheel brakes.

9. The electronically slip-controllable power brake system as recited in claim 1, wherein the brake pressure generator is connected to one of the pressure-medium-actuable wheel brakes in each case via a third pressure medium connection, and a plunger control valve, activatable by the first electronic controller, for controlling the third pressure medium connection is assigned to each of the pressure-medium-actuable wheel brakes.

10. The electronically slip-controllable power brake system as recited in claim 8, wherein the plunger control valve assumes a closed position when de-energized and assumes an open position when energized.

11. The electronically slip-controllable power brake system as recited in claim 1, wherein the brake master cylinder is configured as a single brake master cylinder including exactly one master cylinder chamber delimited by a master cylinder piston.
